(19) United States
(12) Patent Application Publication
(10) Pub. No.: US 2010/0141406 A1
(43) Pub. Date: Jun. 10, 2010

(54) METHOD FOR GROUPING SENSOR NODES IN HETEROGENEOUS WIRELESS SENSOR NETWORKS

(76) Inventors: Jung Hee Jo, Daejeon (KR); Kwang Soo Kim, Daejeon (KR); Yong Joon Lee, Daejeon (KR); Jong-Hyun Park, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/517,014

(22) PCT Filed: Oct. 24, 2007
(86) PCT No.: PCT/KR2007/005238

§ 371 Date: Dec. 29, 2009

(30) Foreign Application Priority Data
Dec. 5, 2006 (KR) 10-2006-0122049
Apr. 9, 2007 (KR) 10-2007-0034686

(51) Int. Cl. G08B 9/00

(52) U.S. Cl. 340/286.02

(57) ABSTRACT

A method for grouping sensor nodes in heterogeneous wireless sensor networks has a sensor network management system. The method includes: receiving a group forming code from the sensor network management system at the respective sensor nodes, wherein the group forming code have sensor conditions and selecting group information from the group forming code in accordance with the conditions at the respective sensor nodes. The method further includes transmitting the selected group information IDs to the sink node.

### TECHNICAL FIELD

The present invention relates to wireless sensor network technology in a wireless environment, and more particularly, to a method for grouping sensor nodes in heterogeneous wireless sensor networks, which is appropriate to remotely upgrade a software code in a sensor node in the wireless sensor networks.

### BACKGROUND ART

The position of a sensor node is variable without being fixed in a wireless sensor network. Sensor nodes operate in cooperation with one another through a sensor network protocol. A sensor node basically has a low power function to be converted to a sleep mode using the minimum power only when it does not communicate, thereby reducing battery consumption. The wireless sensor network of which constituents are this type of sensor nodes, generally includes a sensor region where the sensor nodes are positioned and a sink node which connects the sensor region to an external network.

An operational method using the sensor nodes and the sink node will be described as follows. When a user transmits an inquiry message to a sink node connected to the external network, the sink node forwards the received inquiry message to the sensor region. Then, each sensor node of the sensor region numerically measures information of the conditions, such as temperature, humidity, intensity of illumination, ultraviolet rays and the like, so that the user can receive the data obtained by the sensor nodes as a result of the inquiry. Due to the aforementioned characteristics, sensor nodes are positioned at discretion in a place where it is difficult for people to approach or in a place to rescue people from a disaster or an accident.

In the wireless sensor network, an existing software code which operates in all sensors or a specific sensor needs to be upgraded, or a software code having a new function needs to be installed in the sensor nodes when the need arises.

There has been proposed a method for upgrading the existing software, wherein each of the relevant sensor nodes is manually collected, necessary software codes are installed and distributed to the sensor nodes. However, as the number and kind of sensor nodes have increased by users and needs for the use and the regions where the sensor nodes are distributed have been extended, software codes need to be remotely maintained.

Conventional methods for remotely upgrading a sensor software code will be described below.

FIG. 1 illustrates a conventional grouping model of sensor nodes by using a static tree structure.

Referring to FIG. 1, a number of parent sensor nodes 104 and 106 and a number of child sensor nodes 108 to 114 which are connected to a specific node are statically determined, so that all sensor nodes can keep a tree shape. This shape information is maintained by a sink node 102. When a specific sensor node loses its function due to a malfunction and is deleted from the tree structure or when a new sensor node is inserted into the tree structure for application, the shape of the tree structure is changed. Whenever the shape of the tree structure is changed, the relevant sensor node reports of its shape information to the sink node 102, and the sink node 102 updates and maintains the newly updated tree information.

In this environment, when a sensor software code needs to be upgraded, a user or a sensor network management system 100 transmits the relevant software code to the sink node 102. Then, the sink node 102 refers to the shape information of the sensor nodes which is maintained by the sink node 102, determines a position of the sensor node to be upgraded with respect to the software code, and forwards the software code to the target sensor nodes 108 to 114, via the parent sensor nodes 104 and 106 of the corresponding sensor node.

Generally, a method for forming the static tree structure of the sensors has been applied in a senor network which covers a single domain including the same kind of sensors. However, as the numbers and kinds of the sensor nodes have gradually increased, one sensor network needs to be shared among different application. That is, multi-application has operated in a multi-domain environment formed of heterogeneous sensors. Accordingly, new technology to meet this environment is needed.

To meet the environment of multi-domain and multi-application, there has been suggested a technology to form a dynamic sensor group based on a virtual machine, by improving the method for forming a static sensor group based on the conventional tree structure. This technology has the following basic principles.

FIG. 2 illustrates a conventional grouping model of dynamic sensor nodes.

Referring to FIG. 2, when sensors satisfy specific conditions of a group forming code previously distributed, the sensors belong to a designated group, and, then, if the sensors dissatisfy the conditions, the sensors are deleted from the group. For example, when there is distributed group forming code wherein a condition is that: sensors in a region of which a current temperature is 30? or higher belong to a first group 204; sensors in a region of which the current temperature is between 20? and 30? belong to a second group 206; and sensors in a region of which the current temperature is 10? or lower belong to a third group 208, the sensor nodes dynamically form the first group 204, the second group 206 or the third group 308 according to increase or decrease of the current temperature in the region.

Unlike a conventional method for centrally managing and storing the shape information of a sensor, the technology illustrated in FIG. 2 dynamically forms a group of sensors, thereby providing the flexibility that necessary multi-application in multi- domain can simultaneously operate in one sensor node. However, unlike the method of statically maintaining the shape information of all sensors as described above, since the structure illustrated in FIG. 2 basically pursues “stateless” it has a defect in that any shape information of sensor nodes is not maintained.

In the above-mentioned structure, a method for forwarding a software code is as follows.

FIG. 3 illustrates a transmission section of a software code when the software code is transmitted to a target sensor node in order to update the software code in a grouping environment of dynamic sensor nodes.

Referring to FIG. 3, a user or a sensor network management system 300 forwards a code for upgrade to a sink node 302. Since the sink node 302 has no shape information of each group of sensor nodes, the sink node 302 broadcasts the code to all sensor nodes. Each sensor node receiving the code checks whether it is an end-point of the transmitted code. If the sensor node is the end-point of the transmitted code, it installs the code, and if not, it forwards the code to another sensor node.

In accordance with the aforementioned conventional method for forwarding a software code, the sensor nodes which are not intended to be upgraded by the user or the sensor network management system receive the code for upgrade as well as the sensor nodes supposed to be upgraded and check whether they are the end-point of the code or not. When a sensor node is not the end-point of the code, it transmits the code to another sensor node. As a result, a speed of forwarding the code to the end-point sensor node is slower in comparison with the environment of the static tree structure. Moreover, the method for broadcasting the code to all sensor nodes increases battery consumption which is one of the most important issues in the wireless sensor network.

### DISCLOSURE OF INVENTION

### Technical Problem

It is, therefore, an object of the present invention to provide a method for grouping sensor nodes in heterogeneous wireless sensor networks, which efficiently performs remote upgrade of a software code in the wireless sensor networks and reduces battery consumption of the sensor nodes by proposing a hybrid method which takes advantages of the static structure using the conventional tree shape and the dynamic structure using the virtual machine, to overcome the limitation of the aforementioned conventional technology.

Another object of the present invention is to provide a method for grouping sensor nodes in heterogeneous wireless sensor networks, which efficiently processes transmission of an inquiry code to a sensor node designated in the inquiry code, through a sink node which stores information of a dynamic group of each sensor node and information of a static tree shape, by transmitting a group forming code from a sensor network management system to each sensor node, so that each sensor node is included in a specific group and the sink node receives the information of the group to which each sensor node belongs and the information of the periphery sensor nodes, to remotely transmit the inquiry code to the sensor node in the wireless sensor networks.

### Technical Solution

In accordance with an embodiment of the present invention, there is provided a method for grouping sensor nodes in heterogeneous wireless sensor networks including: receiving a group forming code from a sensor network management system; extracting group information of relevant conditions among group conditions included in the group forming code; transmitting the extracted group information to a sink node; and transmitting information of parent, child and sibling sensor nodes to the sink node by sensing signals of periphery sensor nodes.

In accordance with another embodiment of the present invention, there is provided a method for grouping sensor nodes in heterogeneous wireless sensor networks including: receiving positional shape information from each sensor node and storing the shape information; searching a target sensor node, which is designated in code information transmitted from a sensor network management system, based on the shape information; and transmitting the code information to a path of the searched target sensor node.

### Advantageous Effects

In accordance with the present invention there is provided a method for grouping sensor nodes which enables a transmission of a software code to only a specific sensor node related to a target sensor, thereby improving the speed of transmitting the software code and reducing the battery consumption of a sensor. In addition, the present invention pursuits the merit of the dynamic grouping method thereby making it possible for one sensor to perform an inquiry for multi-application in an environment in which one sensor network is shared among various applications, i.e., multi-application operates in the multi-domain environment formed of different types of sensors.

Furthermore, in the method for grouping sensor nodes in accordance with the present invention, when the sensor network management system transmits the inquiry code for referring to sensor data, the inquiry code can be forwarded to only the specific sensor node designated by the sensor network management system without transmitting the inquiry code to all sensor nodes. In this case, the battery consumption caused in the conventional dynamic grouping method is reduced.

### BRIEF DESCRIPTION OF THE DRAWINGS

The above and other objects and features of the present invention will become apparent from the following description of embodiments given in conjunction with the accompanying drawings, in which:

FIG. 1 is a view illustrating a conventional grouping model of sensor nodes by using a static tree structure;

FIG. 2 is a view showing a conventional grouping model of dynamic sensor nodes;

FIG. 3 is a view presenting a transmission section of a software code when the software code is transmitted to a target sensor node to update a previous software code in a grouping environment of dynamic sensor nodes;

FIG. 4 is a view presenting a method for updating a software code in a grouping environment of a hybrid method in accordance with an embodiment of the present invention;

FIG. 5 is a flow chart illustrating a process for generating metadata in a sensor node and forwarding the metadata to a sink node in accordance with the embodiment of the present invention;

FIG. 6 is a flow chart showing a process for transmitting an inquiry code to a target sensor by a sink node in accordance with the embodiment of the present invention; and

FIG. 7 is a view depicting a list of metadata to be maintained in the sink node in the hybrid method in accordance with the embodiment of the present invention.

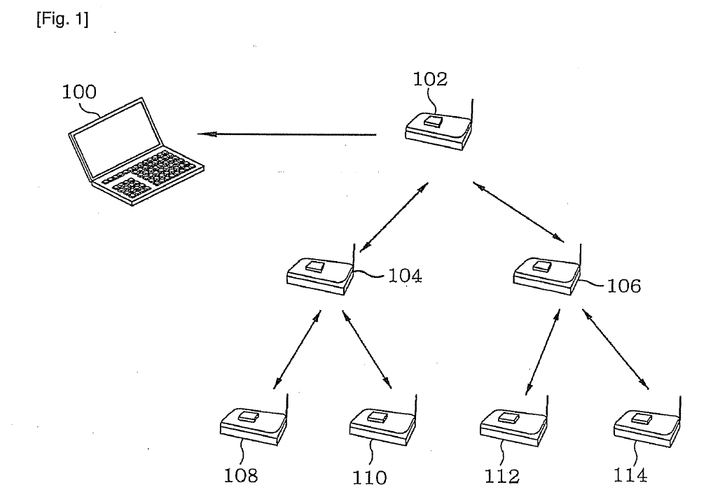

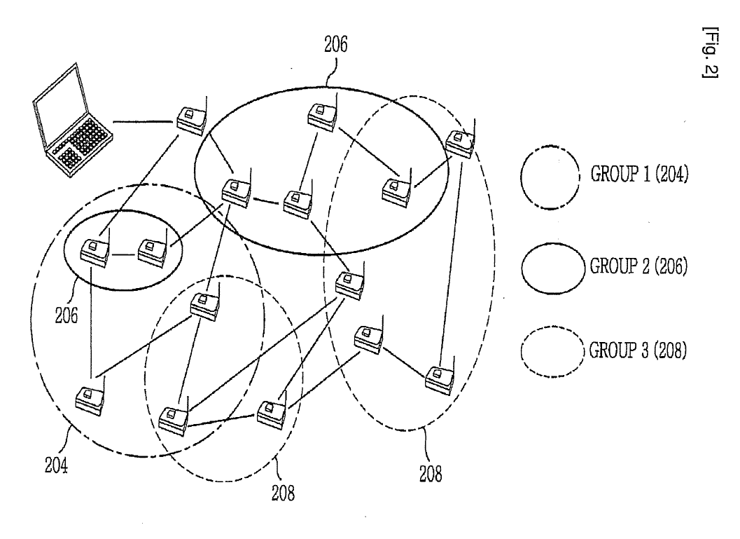

### BEST MODE FOR CARRYING OUT THE INVENTION

Hereinafter, an embodiment of the present invention will be described in detail with reference to the accompanying drawings. In the following description, detailed descriptions for well-known functions or constructions will be omitted in case where they would obscure the invention in unnecessary detail. Below terms, which are defined considering functions in the present invention, can depending on user and operator s intention or practice. Therefore, the terms should be defined on the basis of the disclosure throughout this specification.

The embodiment of the present invention is for upgrading a software code by using a hybrid method which takes advantages of the static structure using the conventional tree shape and the dynamic structure using the virtual machine.

Two conditions are required to implement the present invention. First, when sensor nodes dynamically form groups, the shape information of the sensor nodes needs to be generated and stored in a sink node. Second, when a sensor network management system upgrades a software code, the software code needs to be forwarded to a target sensor node by approaching the shape information of the sensor and designating the target sensor node. Therefore, the multi-application services in a single sensor can be operated in the multi domain environment and the upgrade of the software code also can be forwarded to the designated target sensor node by complementing the defects of the conventional method of broadcasting a code to all sensor nodes.

In a consequence, the present invention provides a method for grouping sensor nodes in wireless sensor networks including heterogeneous sensor nodes to efficiently maintain software which operates in each sensor node.

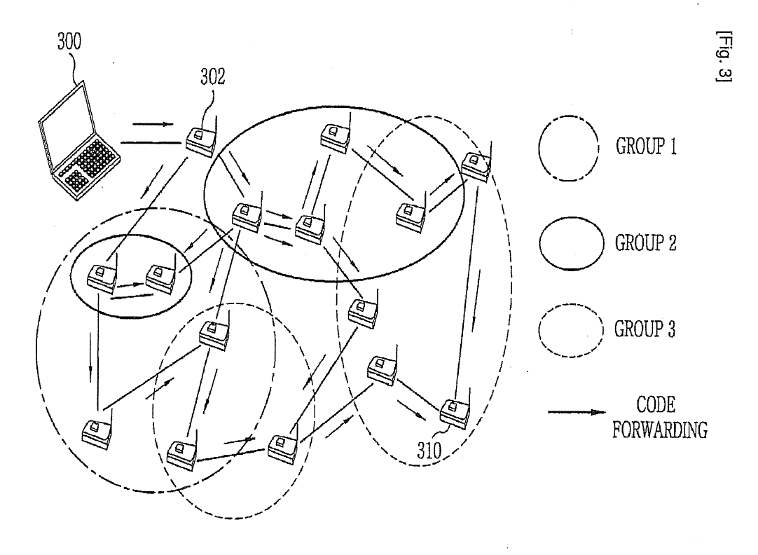

In FIG. 3, when a user or a sensor network management system 300 transmits a software code for update to a sink node 302, the sink node 302 randomly senses signals of the sensor nodes and transmits the software code to sensor nodes having strong signals. Each sensor node receiving the software code also randomly senses signals of its neighboring sensor nodes and transmits the software code to the sensor nodes with strong signals.

This process continues in stages until a target sensor node 310 in the sensor network receives the software code. According to the method of the process, in case the sensor network has fifteen sensors including the sink node 302, since the software code is need to be transmitted to all sensor nodes to reach the target sensor node 310, the software code is transmitted nineteen times in total.

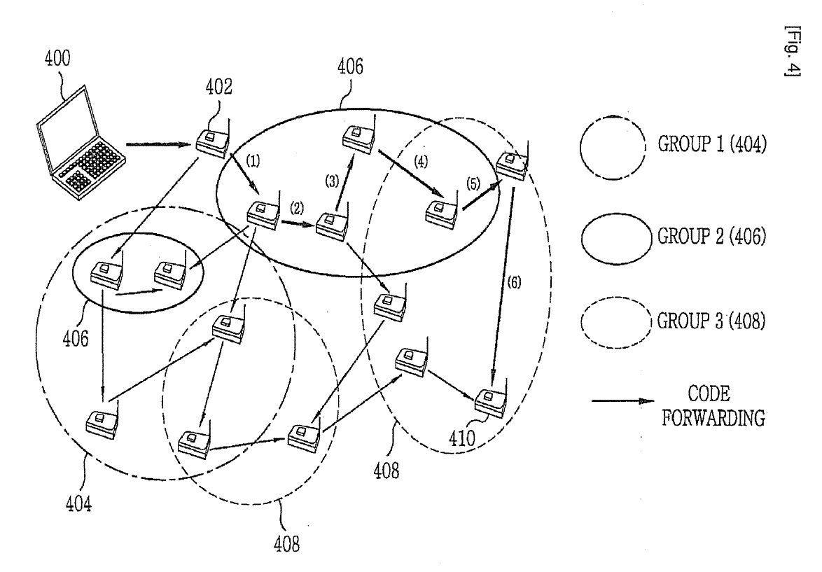

FIG. 4 illustrates a method for updating a software code in a grouping environment of the hybrid method in accordance with an embodiment of the present invention.

Referring to FIG. 4, when a software code is updated in the grouping environment of the hybrid method, sensor nodes form groups at the beginning step by a group forming code which has been previously distributed by a user or a sensor network management system 400. In this process, each sensor node transmits the ID of the group to which the sensor node belongs to a sink node 402, senses signals of the periphery sensor nodes, and transmits the information of its parent, child and sibling sensor nodes to the sink node 402.

For example, it is assumed in the group forming code distributed by the user or sensor network management system 400 that, when a current temperature of a region is 30? or higher, the relevant sensor nodes belong to a first group 404; when the current temperature is between 20? and 30?, the relevant sensor nodes belong to a second group 406; and when the current temperature is 20? or lower, the relevant sensor nodes belong to a third group 408.

In FIG. 4, when a temperature of a specific sensor node is sensed as about 30? or higher, the sensor node belongs to the first group 404 at present. However, when the temperature decreases to about 25?, the sensor node is extracted from the first group 404 and belongs to the second group 406. Then, variation occurs in the tree configuration of the sensor nodes belonging to the first group 404 and the tree configuration of the sensor nodes belonging to the second group 406, and the related information is forwarded to the sink node 402. Accordingly, the sink node 402 continuously maintains the metadata forwarded from the sensor nodes, and the metadata is updated periodically based on the changes in the sensors belonging to the groups or dynamically upon the variation in the tree configuration thereof.

In accordance with FIG. 4, in order for the user or the sensor network management system 400 to designate a target sensor node 410 and to transmit the software code for update, the software code need to be transmitted six times in total, i.e., from a step 1 wherein the software code is transmitted from the sink node 402 to a specific sensor node of the second group 406 to a step 6 wherein the software code is transmitted from a specific sensor node of the third group 408 to the target sensor node, except for the transmission from the user or sensor network management system 400 to the sink node 402.

Unlike the method for broadcasting a software code to all sensors illustrated in FIG. 3, the software code can be transmitted to the specific sensor node since the number of child sensor nodes to be maintained by each sensor node and the maximum depth of the tree are fixedly determined in the group forming code distributed by the sensor network management system 400, and the sink node 402 can extract the path to the target sensor node with reference to the stored metadata.

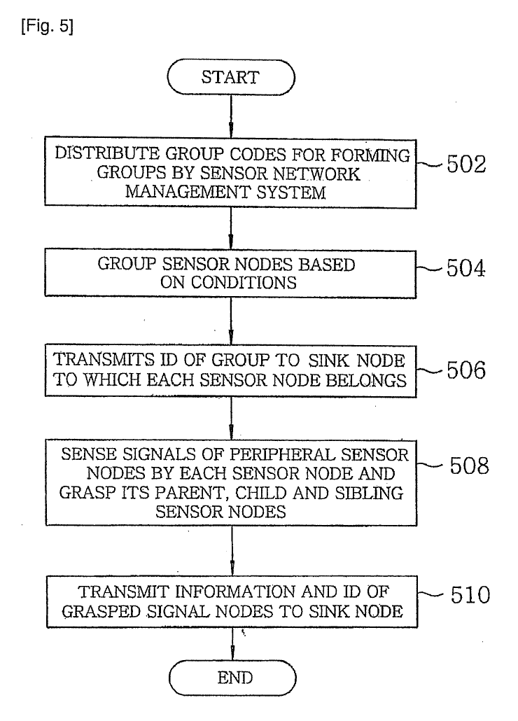

FIG. 5 is a flow chart of a process of generating metadata in a sensor node and forwarding the metadata to a sink node in accordance with the embodiment of the present invention.

Referring to FIG. 5, if a sensor network management system distributes a group forming code at step 502, each sensor node receiving the group forming code selects a group corresponding to the relevant condition and extracts information of the selected at step 504. The sensor node transmits the information of the group to which it belongs (for example, ID of the group) to a sink node at step 506.

Further, each sensor node senses signals of the peripheral sensor nodes and determines its parent, child and sibling sensor nodes at step 508 and transmits information thereof to the sink node at step 510. The step 508 may be performed simultaneously with transmitting the group information when each sensor node receives the group forming code from the sensor network management system. Otherwise, after previously grasping the information of the peripheral sensor nodes, each sensor node may periodically transmit the information to the sink node when the sensor network management system requests the additional information thereof.

FIG. 6 is a flow chart of a process for transmitting an inquiry code to a target senor by a sink node in accordance with another embodiment of the present invention.

Referring to FIG. 6, a sink node receives and stores shape information including changed information periodically from each sensor node at step 602. That is, the shape information includes the group information of a specific sensor node and the information of the parent, child and sibling sensor nodes of the specific sensor node. The shape information is stored as metadata in the sink node.

When an inquiry code requested from a sensor network management system is to be forwarded to a target sensor node, a path to the target sensor node is detected by searching the target sensor node in the stored metadata at step 604, and the information of the inquiry code requested from the sensor network management system is transmitted through the detected path to the target sensor node at step 606.

By the aforementioned process, the inquiry code requested from the sensor network management system is fast transmitted to the target sensor node, and the requested inquiry code may relate to the measurement of any specific parts or the software upgrade in the target sensor node.

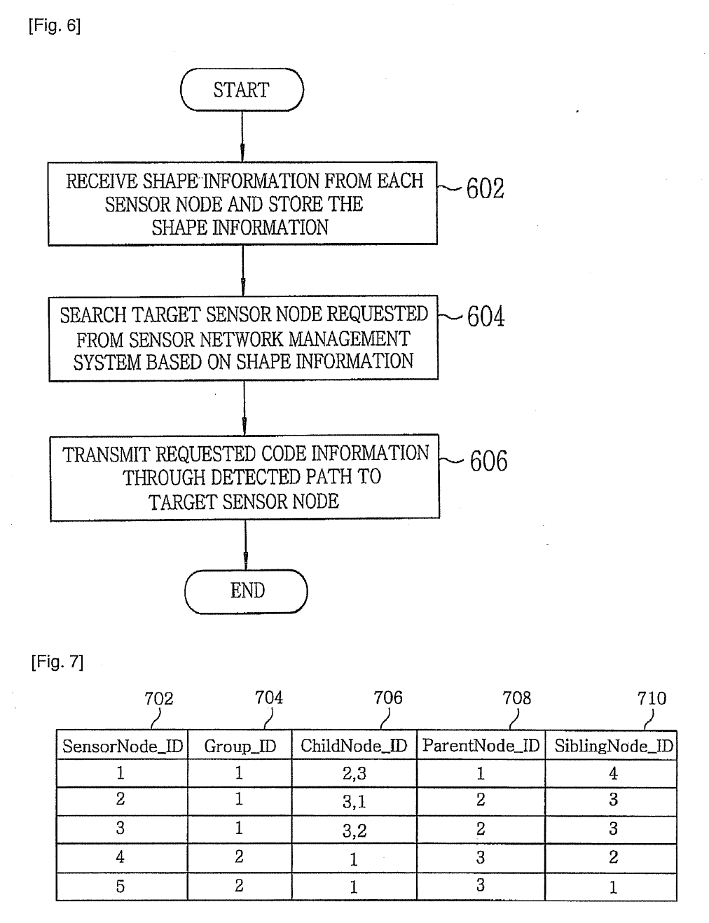

FIG. 7 illustrates a list of metadata to be maintained in a sink node in the hybrid method in accordance with the embodiment of the present invention.

Referring to FIG. 7, the metadata stored in the sink node may include sensor node ID 702, group ID 704, child ID 706, parents ID 708, sibling ID 710. The ID of each sensor node 702, information of a group, and information of parent, sibling and child sensor nodes are stored and periodically updated with respect to changed matters of each sensor node. Accordingly a response can be made to an inquiry request of specific sensor nodes, a request for sensor information or a request for software upgrade from a sensor network management system.

Moreover, when the sensor network management system transmits an inquiry to refer to sensor data by performing the grouping method according to the present invention, it is possible to forward the inquiry to a specific sensor node only without transmitting the inquiry to all sensors, so that the number of times for transmitting a software code to the sensor nodes can be reduced.

As described above, the present invention is to perform the upgrade of a software code in a sensor node by using a hybrid method which takes advantages of the static structure using the conventional tree shape and the dynamic structure using the virtual machine for upgrading the software code.

1. A method for grouping sensor nodes in heterogeneous wireless sensor networks having a sensor network management system and a sink node comprising:
receiving a group forming code from the sensor network management system at the respective sensor nodes, wherein the group forming code have sensor conditions;
selecting group information from the group forming code in accordance with the conditions at the respective sensor nodes; and
transmitting the selected group information IDs to the sink node.

2. The method of claim 1, further comprising:
sensing signals generated from the sensor nodes neighboring each of the sensor nodes to recognize relationship information on parent, child and sibling sensor nodes thereof; and
transmitting the relationship information to the sink node.

3. The method of claim 1, wherein the group information includes group identifications (IDs) designating groups to which the respective sensor nodes belong.

4. The method of claim 1, wherein when the IDs and the relationship information are changed in accordance with the condition, the changed IDs and relationship information is transmitted to the sink node.

5. A method for transmitting a query code to sensor nodes grouped in heterogeneous wireless sensor networks having a sink node, the sink node is provided with positional shape information indicative of locations at which the respective belong in each group, the method comprising:
searching a target sensor node to which the query code is transmitted based on the shape information when receiving the query code at the sink node; and
transmitting the query code through a path of the positional shape information to the searched target sensor node.

6. The method of claim 5, further comprising:
monitoring the change of the positional shape information.

7. The method of claim 6, wherein the step of monitoring the change of the positional shape information comprises:
checking whether a specific sensor node is released from a current location; and
updating the shape information based on the changed shape information.

8. The method of claim 5, wherein the query code includes a software upgrade for the target sensor node.

9. The method of claim 5, wherein the query code includes a measurement request by the target sensor.
